(19) United States
(12) Patent Application Publication
(10) Pub. No.: US 2024/0416751 A1
(43) Pub. Date: Dec. 19, 2024

(54) Electronic Vehicle Servicing Record

(71) Applicants: Johans Gallo, El Cajon, CA (US); Jesse Gallo, El Cajon, CA (US)

(72) Inventors: Johans Gallo, El Cajon, CA (US); Jesse Gallo, El Cajon, CA (US)

(21) Appl. No.: 18/745,831

(22) Filed: Jun. 17, 2024

Related U.S. Application Data
(60) Provisional application No. 63/521,416, filed on Jun. 16, 2023.

(51) Int. Cl. B60K 35/22; G07C 5/00

(52) U.S. Cl. CPC B60K 35/22; G07C 5/006; B60K 2360/16

(57) ABSTRACT

An adhesive-adhereable device is provided which includes a computer processor and at least one display for depicting alphanumeric characters thereon. Future service dates for the vehicle may be programmed into it using software adapted to that task running in electronic memory. The user is then provided with indicia on the display at a future date as to the service requirement and may also be provided with an audible and a visual alarm.

This application claims priority to U.S. Provisional Patent Application Ser. No. 63/521,416 filed on Jun. 16, 2023.

### FIELD OF THE INVENTION

The present device relates to the servicing of vehicles such as the changing of engine oil. More particularly, the disclosed device relates to a service record sticker which provides electronic input and electronic display of a service record for the vehicle to which it is attached.

### BACKGROUND OF THE INVENTION

The motor vehicle has become a primary means for the transport of people and freight in most modern countries. A vast majority of motor vehicles, such as automobiles and trucks employed for such transport, are powered by internal combustion engines.

Internal combustion engines while providing very reliable power to automobiles and trucks must be properly and timely serviced to maintain the engine in operating condition. Additionally, vehicles, whether electrically powered or powered by internal combustion engines, also require timely service to the running components thereof, such as the suspension and braking system to maintain road worthiness.

Conventionally, when a service is provided to a vehicle in ongoing maintenance thereof, a record of such service is recorded by the provider. This record is also frequently recorded in a legible fashion and adhered to the vehicle, so the current owner will have a visual record of the type of recent service and date and vehicle mileage on that date. This allows the vehicle owner or user to determine a future service requirement, either by the future date from the last recorded service or time for service based on future milage of the vehicle.

Conventionally, such legible records for the vehicle owner or user are configured as adhereable stickers. Such stickers, for example, are widely employed to record oil changes and are adhered to the interior of the windshield of the vehicle serviced.

The forgoing background concerning the conventional manner in which vehicle service records are recorded and engaged with the vehicle being serviced, and the limitations related therewith are intended to be illustrative and not exclusive, and they do not imply any limitations on the invention described and claimed herein. Various other limitations of the related art of vehicle service records are known or will become apparent to those skilled in the art upon a reading and understanding of the specification below and the accompanying drawings.

### SUMMARY OF THE INVENTION

The vehicle service recording and display device herein is configured with a flexible body which is adapted, in a preferred mode of the device, to an adhesive engagement to an interior surface of a motor vehicle windshield or other exposed glass surface. The flexible body has dimensions, preferably, substantially the size of a credit card. However, it may be larger or smaller should the requirements for display, input, or electronic storage and power require it.

In all modes of the device herein, it is preferred that one or a plurality of electronic displays are positioned for viewing thereof on a front surface or layer of the flexible body. Such will allow for the depiction of a servicing date and vehicle mileage on that servicing date for ongoing review by the vehicle owner or user. Using the depicted mileage and date information, the user will be able to calculate or otherwise determine when the vehicle requires service again in the future.

The flexible body housing the electronic displays and requisite circuitry is, as noted, preferably, formed of flexible material, such as a vinyl or other polymeric or plastic material. On a rear surface or layer of the body is preferably located an adhesive surface. Such initially will be covered with a removable sheet of material in a familiar peel and stick configuration. Adhering the rear surface of the body of the device to a windshield interior will thus position the electronic displays and input area viewable by the vehicle owner or user once mounted.

Electric power for the device is provided in all modes herein, preferably, by a solar panel having sufficient solar cells thereon to generate sufficient electric power for the circuits and displays of the device herein. Preferably, the solar panel is positioned on or operatively adjacent to the rear surface layer of the body of the device herein. A slow discharge capacitor or thin film rechargeable battery may be provided to store electric power generated by the solar panel and communicate such to any electronic components of the device requiring it. In some cases, such an electric power storage component may not be required in some instances where the displays and input have sufficient electric power in real time provided by the solar panel.

Engaged to the flexible body of the device herein, in addition to one or a plurality of electronic displays for text or other indicia, are the electronic components required to operate the device. Such, for example, will be a computer processor having onboard or connected electronic memory which will run software operating to the task of inputting data concerning a service date and vehicle mileage.

As to electronic memory or computer readable media for the system herein, any combination of one or more computer-usable or computer-readable media, be it transitory or non-transitory, may be employed for operation of the software and for the reminder and alarm system, Such, for example and in no way limiting, can include computer-readable media and may include a random access memory device, a read-only memory device, an erasable programmable read-only memory (EPROM or Flash memory) device, and other electronic memory magnetic storage devices. Software or computer program code for carrying out the individual and sequential operations and alarm and reminder assessments of the present invention may be written in any combination of one or more programming languages.

Input of such programming data, such as date and mileage indicia, for depiction on the onboard video displays in a preferred mode of the device with the least function and cost, can be accomplished by contact areas or “buttons” allowing the provider or vehicle user to input the date of service of a vehicle and the mileage on that date by contact with the contact areas which will actuate onboard software to allow the user to choose dates and mileage and other input information or programming data.

In another mode of the device, allowing for remote input, software running in electronic memory and processed by the onboard computer processor can also be configured to allow for wireless input of the appropriate of the programming data such as mileage and date and other information. A wireless transceiver, using a low power transmitting and receiving system on the flexible body, can communicate with a remote computing device, such as a smartphone or transmitting computer, which will be employed for data input.

The remote computing device will have the appropriate electronic processors and electronic memory to run an input software application operating to allow the user to input the data to the remote computing device which will be wirelessly communicated to the sticker electronics wherein the displays will depict the information, such as servicing date and vehicle mileage. Of course, the device herein, having electric displays for depiction of servicing information, is not limited to mileage and servicing date. Other information, germain to the operation and maintenance of the motor vehicle, can also be tracked and included in electronic depictions for the vehicle owner or user to view.

With respect to the above description, before explaining at least one preferred embodiment of the herein disclosed electronic vehicle servicing record device and system in detail, it is to be understood that the invention is not limited in its application to the details of construction and to the arrangement of the components in the following description or illustrated in the drawings. The adhereable sticker for provision of an electronic record of a service provided a vehicle herein described and disclosed is capable of other embodiments and of being practiced and carried out in various equivalent ways which will become obvious to those skilled in the art upon reading this disclosure. Also, it is to be understood that the phraseology and terminology employed herein are for the purpose of description and should not be regarded as limiting.

As such, those skilled in the art subsequent to reading this disclosure will appreciate that the conception upon which this disclosure is based, may readily be utilized as a basis for the designing of other adhereable electronic service record displays and substantially equivalent structures methods and systems for carrying out the several purposes of the present disclosed device. It is important, therefore, that the claims be regarded as including such equivalent configurations, constructions and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The term “substantially”, unless otherwise specifically defined, means plus or minus five percent.

It is an object of the present invention to provide an adhereable sticker for a vehicle which will electronically display and store records of servicing provided to the vehicle on which it is mounted.

It is an additional object of this invention to provide such an adhereable sticker, having a body and displays and electronics for recording and displaying vehicle service records, which requires no battery and is solar powered.

It is yet another object of this invention to provide a portable electronic sticker which may be programed to remind or warn users about future service dates and services for the vehicle or device to which it is attached.

These and other objects, features, and advantages of the present adhereable display for vehicle service records as well as the advantages thereof over existing prior art, which will become apparent from the description to follow, are accomplished by the improvements described in this specification and hereinafter described in the following detailed description which fully discloses the electronic display and storage of service records of a vehicle, but should not be considered as placing limitations thereon.

### BRIEF DESCRIPTION OF DRAWING FIGURES

The accompanying drawings, which are incorporated herein and form a part of the specification, illustrate some, but not the only or exclusive examples of embodiments and/or features of the disclosed adhesive-adhereable electronic vehicle service record display and configuration herein. It is intended that the embodiments and figures disclosed herein are to be considered illustrative of the invention herein, rather than limiting in any fashion.

In the drawings:

FIG. 1 depicts a view of a front side surface of the flexible body of the adhereable sticker showing the electronic display for depiction of a servicing date and the mileage of the vehicle on that date.

FIG. 2 shows the rear side surface of the adhereable sticker showing an adhesive area for attachment to a windshield of a vehicle and a solar cell which provides electric power to the device herein.

FIG. 3 depicts a simple depiction of the electronic components of the sticker record device which is positioned preferably in a central layer of the body of the sticker between the front and rear side surfaces.

FIG. 4 depicts a sectional view of the device through a line 4-4 of FIG. 2 showing the stacked or layered configuration of the center layer having electronics thereon positioned in-between the front layer and rear layer.

### DETAILED DESCRIPTION OF THE INVENTION

In this description, the directional prepositions of up, upwardly, down, downwardly, front, back, top, upper, bottom, lower, left, right, first, second, and other such terms refer to the configuration of the adhereable electronic vehicle record display flexible body 14 and system herein as it is oriented and appears in the drawings and all such terms are used for convenience only and such are not intended to be limiting or to imply that the disclosed device has to be used or positioned in any particular orientation.

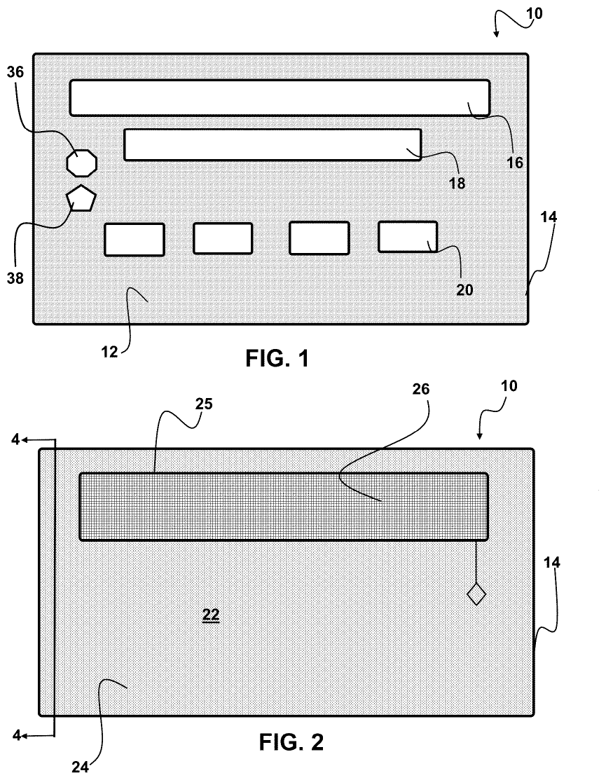

Now referring to drawings in FIGS. 1-4, wherein similar components are identified by like reference numerals, there is seen in FIG. 1 a simple depiction of a front side surface 12 of the body 14 of the adhereable sticker device 10 herein. In all preferred modes, the front side surface 12 will have at least one or a first electronic display 16 such as a lower power usage LCD type display from Sharp Manufacturing.

This first electronic display 16 may be configured to display in alphanumeric digits all the information about a service requirement, service date, or mileage threshold for service, of the vehicle to which the body 14 is engaged. Alternatively, a second electronic display 18, similar to that of the first electronic display 16 or more, can be positioned to display the service and other information stored for the user which is considered appropriate for operation and service of the vehicle.

An input component for input of the data to generate alpha numeric information to be displayed and/or employed by the service calculating software to generate the displayed information on at least the first electronic display 16, in a simple mode of the device 10, will be accomplished by contact of the user with input areas 20 or “buttons.” As noted, such data input can also be accomplished using an input component in the form of wireless transmission via Blue tooth, Wi-Fi, or optical transmissions through a transceiver 30. The transceiver 30 as the input component may be preferred in many applications for ease of data input.

Touching the input areas 20 in the mode of the device 10 using them for an input component will actuate onboard data input software to generate choices for input dates and mileage and other information whereupon touching the input areas 20 one or more times will hold the input data in electronic memory. Another wireless transmitter, such as a smartphone or computer, may be employed to communicate data input to the device 10 in place of or in combination with the input areas 20.

Shown in FIG. 2 is the rear surface layer 22 of the flexible body 14 of the device 10 herein. As shown, an adhesive area 24 covers a majority of this surface and, preferably, is positioned around the entire perimeter of the body 14 and in the area within, to insure a secure adhesive mount to a windshield or other surface of the vehicle which will have sunlight communicated thereto.

Also shown positioned on the body 14 of the device on the rear or in a layer adjacent thereto is the solar panel 26, such as a mini polycrystalline solar cell which generates electric current to power the displays and electronics of the device 10 herein. It is preferable that the solar panel 26 is under a clear or transparent layer area 25 of adhesive 24 such that the adhesive 24 is optically clear enough so as to maximize the contact of sunlight communicated through the windshield of the vehicle to the solar panel 26.

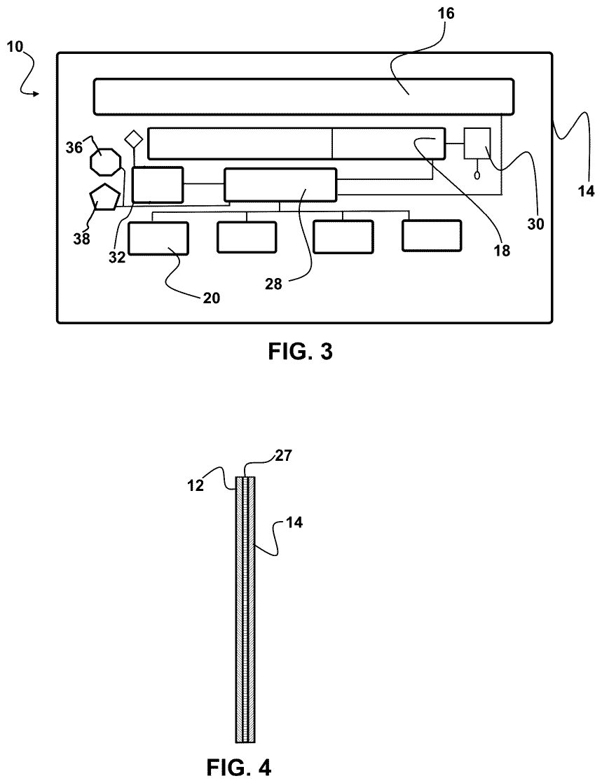

Shown in FIG. 3, as noted, is a simple depiction of the electronic components and circuits to operate the device 10 herein, which of course, can be varied by those skilled in the art as needed. The electronic portion depicted is preferably positioned on a center layer 27 in between the front surface 12 and rear surface 14 such that it is protected thereby. In this configuration, the first electronic display 16 and second electronic display 18 and the LED 36 and audible alarm 38, such as buzzer or loudspeaker or noisemaker, will be positioned preferably in cut out areas of the front surface 12 so as to be operatively positioned for hearing the alarms and viewing the LED alerts and viewing the depicted indicia upon the two electronic displays 16 and 18.

As shown, the first electronic display 16 and/or the second electronic display 18 will receive electronic communication from a microprocessor or computer processor 28 to run service calculating software in electronic memory thereof or attached thereto. The service calculating software will operate to the task of taking inputted signals from contact with the input areas 20 and generating data and communicating signals to any electronic displays onboard to generate the alphanumeric indicia required for viewing the device 10 in operation. The service calculating software may also activate one or a combination of alarm components.

Such, for example, as noted, may be digits or indicia of letters and numbers communicated to display in alphanumeric digits the information about one or a combination of servicing requirements for the vehicle from a group including a type of service requirement, a service date, or a mileage threshold for future vehicle servicing. The digits or alphanumeric characters for the indicia can be generated upon the first electronic display 16 or second electronic display 18 but may also be other depictable and viewable data for the user, as required for the vehicle or user.

As noted, the input data may be accomplished using the input areas 20 or “buttons” positioned for contact by the user for such. Contacting the input areas 20 with a finger will send an electronic signal to the computer processor 28 and service calculating software thereon operating to the task at hand, to generate future dates and times and mileage and the like as well as alarms. This would occur during indicia depictions communicated from the microprocessor to one of the electronic displays 16 and 18 which are operated by the service calculating software operating to the task of generating inquiries about the current date, future dates for service, current milage, future mileages thresholds for service, and other input data allowing the device 10 to operate for a current task.

For example only, service calculating software running in electronic memory on or connected to the processor 28 may operate to ask the user to input a current date, a current vehicle mileages, a future date of suggested service for the vehicle, and a future mileage threshold the vehicle may reach which would require a service. As another example only, where a warranty service occurred or parts have been installed on the vehicle, the input data may be for instance a follow up date for inspection, and/or the part number or warranty issue handled.

Also, as noted, the device 10 herein can operate using wirelessly transmitted data to and from a transceiver 30, such as an RF or optical wireless receiver or RFID. This will allow the use of remote computing devices, such as smartphones or laptops or other computers, to run applications which allow the user to input the alphanumeric and other data required of the onboard service calculating software operating to thereby generate the alphanumeric indicia on the displays 16 or 18, positioned on the body 14, and to actuate the visual and sonic alarms provided by the LED 36 and the audible alarm 38.

Also shown, as part of the simple circuitry depiction of the device 10 is an electric current storage component 32, such as a battery or slow discharge capacitor, which may be placed in operative communication with the solar panel 26 to allow it to receive generated electricity therefrom and to then store electric energy. The electric current storage component 32 will thereafter provide electric current to the device 10, such as to the electronic displays 16 and 18 and to the computer processor 28 as needed to operate them.

An additional function of the device 10 may be provided by a visual and/or audible alarm. The alarm may be communicated by a light generating device such as an LED 36 or small audible alarm 38 or noise generating component. This is especially preferred to help the user remember to look at the device 10 when a service is due such as an oil change or a visit to the dealer for required services to the vehicle.

The service calculating software running in memory on or connected to the computer processor 28 may also operate to the task of receiving a future service or activity date from the user or service provider, and a designated service or action, and on or at a designated period before that future date, it will activate one or both of the visual alarm such as the LED 36 and audible alarm 38, such as a loudspeaker or buzzer or the like, to cause a user to look at the device 10. Concurrently, the alarm activity of the service calculating software will generate a service message of alphanumeric characters on one or both of the electronic displays 16 and 18 informing the user of the service or visit or other action required based on the previously input alarm date. In this fashion, the device 10 may act as a calender reminder for service and required visits or actions for keeping the vehicle operating according the specifications from the manufacturer.

Using the transceiver 30, the alarm software may also operate to send a WiFi or bluetooth or similar signal to the smartphone of the user. This may be done concurrently with the audible and visual alarm or at a different time. The signal sent will be generated by the alarm software running in the electronic memory connected to the computer processor 28 in a form adapted to actuate an application on the user's phone or computer to display the task required at the future date.

As shown in FIG. 4, the device 10 may be formed in a layered configuration using adhesive to hold the layers together to form the device 10. As shown, the center layer 27 having electronics thereon is positioned between the front layer 12 and rear layer 14. There would be cut out areas in the rear layer 14 for the area of the solar panel 26 and likewise in the front layer 12 for at least the first electronic display 16 and second electronic display 18, if present. For ease of sight and hearing, cut out areas for the area of the LED 36 and the audible alarm 38, if present, would be preferred but not totally necessary. It is preferable that the material forming all three layers is flexible such that it will bend and assume the curves and contours on which the device 10 is placed. A polymeric material, such as polyethylene or a vinyl or other flexible material as would occur to those skilled in the art may be used so it may for example easily engage to and adopt the curve or contour of a windshield.

As noted, any of the different configurations and components and steps in the system shown and described herein can be employed with any other configuration or component shown and described as part of the electronic vehicle record display and storage system herein. Additionally, while the disclosed invention has been described herein with reference to particular embodiments thereof and components thereof operatively engaged for operation, a latitude of equivalent modifications, various changes and substitutions are intended in the foregoing disclosures and it will be appreciated that in some instance some features, or configurations, or operations of the invention could be employed without a corresponding use of other features without departing from the scope of the invention as set forth in the following claims. All such changes, alternations and modifications as would occur to those skilled in the art subsequent to reviewing this specification, are considered to be within the scope of this invention as broadly defined in the appended claims.

Further, the purpose of any abstract of this specification is to enable the U.S. Patent and Trademark Office, the public generally, and especially the scientists, engineers, and practitioners in the art who are not familiar with patent or legal terms or phraseology, to determine quickly from a cursory inspection the nature and essence of the technical disclosure of the application. Any such abstract included herein is neither intended to define the invention of the application, which is measured by the claims, nor is it intended to be limiting, as to the scope of the invention in any way.

What is claimed is:

1. An electronic vehicle servicing record apparatus for positioning upon a windshield of a vehicle, comprising:
a body, said body being planar and flexible;
said body having a rear surface, said rear surface configured for engagement to a windshield of a vehicle to an as-used position thereon;
said body having a front surface opposite said rear surface;
a first electronic display;
a computer processor engaged with said body, said computer processor in communication with electronic memory running service calculating software operating to the tasks of receiving input data and thereafter generating alphanumeric characters upon said first electronic display;
an electric current storage component communicating electric current to said computer processor and said first electronic display;
a data input component for communicating said input data to said electronic memory; and
said display configured to display, in alphanumeric digits, information about one or a combination of future servicing requirements for said vehicle from a group including a type of service requirement, a service date, or a mileage threshold for future vehicle servicing.

2. The electronic vehicle servicing record apparatus of claim 1 wherein said data input component is at least one input area which generates said input data upon contact of said input area with a finger of a user.

3. The electronic vehicle servicing record apparatus of claim 1 wherein said data input component is a transceiver for wirelessly communicating said input data to said electronic memory.

4. The electronic vehicle servicing record apparatus of claim 1 wherein said electronic electric current storage component is one of a battery or a slow discharge capacitor.

5. The electronic vehicle servicing record apparatus of claim 2 wherein said electronic electric current storage component is one of a battery or a slow discharge capacitor.

6. The electronic vehicle servicing record apparatus of claim 3 wherein said electronic electric current storage component is one of a battery or a slow discharge capacitor.

7. The electronic vehicle servicing record apparatus of claim 4 additionally comprising:
a solar panel connected to said electronic storage component, said solar panel communicating a recharging of said electric current stored in said electronic storage component.

8. The electronic vehicle servicing record apparatus of claim 5 additionally comprising:
a solar panel connected to said electronic storage component, said solar panel communicating a recharging of said electric current stored in said electronic storage component.

9. The electronic vehicle servicing record apparatus of claim 6 additionally comprising:
a solar panel connected to said electronic storage component, said solar panel communicating a recharging of said electric current stored in said electronic storage component.

10. The electronic vehicle servicing record apparatus of claim 7 additionally comprising:
said service calculating software operating to the additional task of activating an alarm component;
said alarm component being one or a combination thereof from a group of alarm components including an LED and an audible alarm; and
said alarm components generating a visual and/or audible alarm when activated by said service calculating software.

11. The electronic vehicle servicing record apparatus of claim 8 additionally comprising:
said service calculating software operating to the additional task of activating an alarm component;
said alarm component being one or a combination thereof from a group of alarm components including an LED and an audible alarm; and
said alarm components generating a visual and/or audible alarm when activated by said service calculating software.

12. The electronic vehicle servicing record apparatus of claim 9 additionally comprising:
said service calculating software operating to the additional task of activating an alarm component;
said alarm component being one or a combination thereof from a group of alarm components including an LED and an audible alarm; and
said alarm components generating a visual and/or audible alarm when activated by said service calculating software.

13. The electronic vehicle servicing record apparatus of claim 10 additionally comprising:
transparent adhesive positioned upon said rear surface of said body.

14. The electronic vehicle servicing record apparatus of claim 11 additionally comprising:
transparent adhesive positioned upon said rear surface of said body.

15. The electronic vehicle servicing record apparatus of claim 12 additionally comprising:
transparent adhesive positioned upon said rear surface of said body.
